(19) United States
(12) Patent Application Publication
(10) Pub. No.: US 2016/0337922 A1
(43) Pub. Date: Nov. 17, 2016

(54) RAN-WLAN Traffic Steering

(71) Applicant: Nokia Technologies Oy, Espoo (FI)

(72) Inventors: Jari MUSTAJARVI, Espoo (FI); Janne TERVONEN, Espoo (FI)

(21) Appl. No.: 14/712,209

(22) Filed: May 14, 2015

(51) Int. Cl. H04W 36/22; H04W 28/08; H04W 48/00

(52) U.S. Cl. CPC H04W 36/22; H04W 48/17; H04W 28/08; H04W 88/02

(57) ABSTRACT

A method including receiving a subscriber profile for a user equipment (UE) in WLAN network by a radio access network (RAN); and the radio access network (RAN) performing traffic steering for the user equipment (UE) between the radio access network (RAN) and a wireless local area network (WLAN) based, at least partially, upon the subscriber profile.

### BACKGROUND

1. Technical Field

The exemplary and non-limiting embodiments relate generally to wireless communication and, more particularly, to operating within a radio access network and a WLAN network.

2. Brief Description of Prior Developments

Conventional UEs are able to operate by use of a RAN or by use of a WLAN.

### SUMMARY

The following summary is merely intended to be exemplary. The summary is not intended to limit the scope of the claims.

In accordance with one aspect, an example method comprises receiving a subscriber profile for a user equipment (UE) in a wireless local area network (WLAN) by a radio access network (RAN); and the radio access network (RAN) performing traffic steering for the user equipment (UE) between the radio access network (RAN) and at least one wireless local area network (WLAN) based, at least partially, upon the subscriber profile.

In accordance with another aspect, an example embodiment is provided in an apparatus comprising at least one processor; and at least one non-transitory memory including computer program code, the at least one memory and the computer program code are configured to, with the at least one processor, cause the apparatus to: receive a subscriber profile for a user equipment (UE) in a wireless local area network (WLAN) by the apparatus, where the apparatus forms at least part of a radio access network (RAN); and the apparatus performing traffic steering for the user equipment (UE) between the radio access network (RAN) and at least one wireless local area network (WLAN) based, at least partially, upon the subscriber profile.

In accordance with another aspect, an example method comprises transmitting an authorization request from a wireless local area network (WLAN) to a radio access network (RAN) for a user equipment (UE); and transmitting a subscriber profile for the user equipment (UE) by the wireless local area network (WLAN) to the radio access network (RAN).

In accordance with another aspect, an example embodiment is provided in an apparatus comprising at least one processor; and at least one non-transitory memory including computer program code, the at least one memory and the computer program code are configured to, with the at least one processor, cause the apparatus to: transmit an authorization request from the apparatus to a radio access network (RAN) for a user equipment (UE), where the apparatus is at least part of a wireless local area network (WLAN); and transmit a subscriber profile for the user equipment (UE) by the apparatus to the radio access network (RAN).

### BRIEF DESCRIPTION OF THE DRAWINGS

The foregoing aspects and other features are explained in the following description, taken in connection with the accompanying drawings, wherein:

FIG. 1 is a diagram illustrating an example of an overall architecture of a E-UTRAN (evolved UMTS Terrestrial Radio Access) system (an air interface of 3GPP's Long Term Evolution (LTE) upgrade path for mobile networks);

FIG. 2 is a diagram illustrating an example of a User Equipment (UE) in partially overlapping cells;

FIG. 3 is a diagram illustrating some components of the wireless system shown in FIGS. 1 and 2;

FIG. 4 is a diagram illustration example operations;

FIG. 5 is a diagram illustrating an example method; and

FIG. 6 is a diagram illustrating an example method.

### DETAILED DESCRIPTION OF EMBODIMENTS

The following abbreviations that may be found in the specification and/or the drawing figures are defined as follows:
3GPP Third Generation Partnership Program
AAA Authentication, Authorization and Accounting
AP Access Point
BSS Basic Service Set
CC Component Carrier
CCA Clear Channel Assignment
CRS Cell Specific Reference Signal
CSI Channel State Information
CSI-RS Channel State Information Reference Signal
DCI Downlink Control Information
DL Downlink
E-UTRAN Evolved UMTS Terrestrial Radio Access Network
EAP Extensible Authentication Protocol
eNB/eNodeB enhanced Node B (base station according to LTE terminology)
EPC Enhanced Packet Core
EPDCCH Enhanced PDCCH
ID Identity
IE Information Element
IMSI International Mobile Subscriber Identity
LAA License-Assisted Access
LTE Long Term Evolution
MAC Media Access Control
O&M Operations and Maintenance
OFDM Orthogonal Frequency Division Multiplexing
OFDMA Orthogonal Frequency Division Multiple Access
PCell Primary Cell
PDCCH Physical Downlink Control CHannel
PDSCH Physical Downlink Shared CHannel
PLMN Public Land Mobile Network
PRB Physical Resource Block
PSS Primary Synchronization Signal
QoS Quality of Service
RAN Radio Access Network
RRC Radio Resource Control
Rel Release
RNTI Radio Network Temporary Identifier
RRM Radio Resource Management
SCell Secondary Cell
SCS Short Control Signalling
SSS Secondary Synchronization Signal
SDL Supplemental DL
TB Transport Block
TD/TDD Time Division duplex
TL Threshold Level
UE User Equipment
UL Uplink
UMTS Universal Mobile Telecommunications System
UTRAN Universal Terrestrial Radio Access Network
WLAN Wireless Local Area Network
X2 X2 is an interface used to communication between eNBs

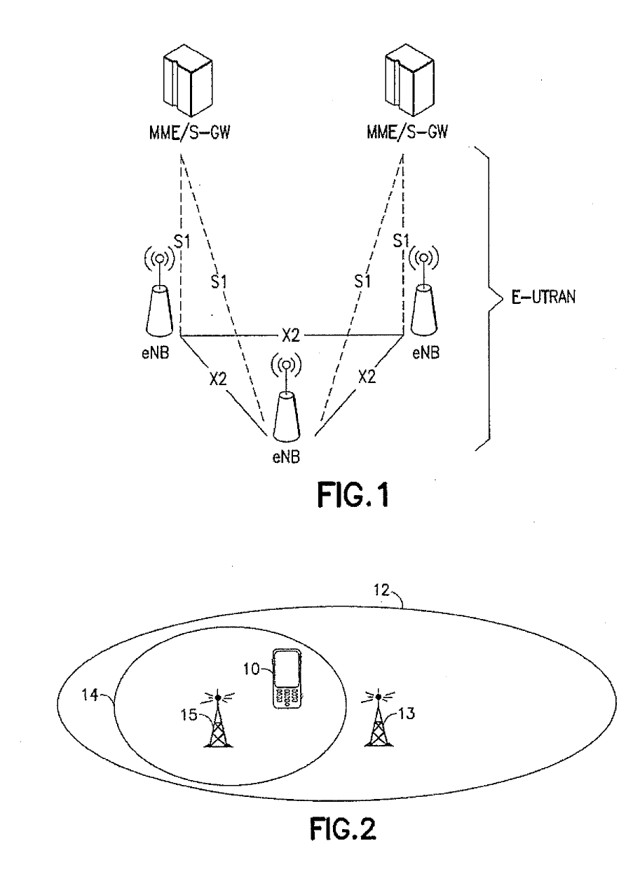

FIG. 1 shows an example of overall architecture of an E-UTRAN system. The E-UTRAN system is one example of a radio access network (RAN). In an alternate example, features as described herein may be used in a UTRAN system. A UTRAN system is another example of a RAN. As further understood from the description below, with features as described herein the counterpart for a WLAN in an E-UTRAN system is the eNB. However, in UTRAN the counterpart of the WLAN would be the RNC which controls the nodeB resources.

For the example shown in FIG. 1, the E-UTRAN system includes eNBs, providing an E-UTRAN user plane (PDCP/RLC/MAC/PHY) and control plane (RRC/RLC/MAC/PHY) protocol terminations towards the UE (not shown in FIG. 1). The eNBs are interconnected with each other by means of an X2 interface. The eNBs are also connected by means of a S1 interface to an EPC (Enhanced Packet Core), more specifically to a MME (Mobility Management Entity) by means of a S1 MME interface and to a Serving Gateway (S-GW) by means of a S1 interface. The S1 interface supports a many-to-many relationship between MMEs/S-GW and eNBs.

Features as described herein may be used in regard to WLAN offloading. However, features may also be used in regard to carrier aggregation (CA). With features as described herein, an UE may be configured or instructed to utilize operator provided WLAN services (such as based on SSID for example), but the overlay 3GPP network (RAB) may be used to finally grant permission to use the WLAN network with the UE when the UE contacts the WLAN network. The 3GPP network may, for example, deny WLAN service to protect a WLAN service level for existing WLAN users, or to keep an UE in the 3GPP network as long as it provides a good service level.

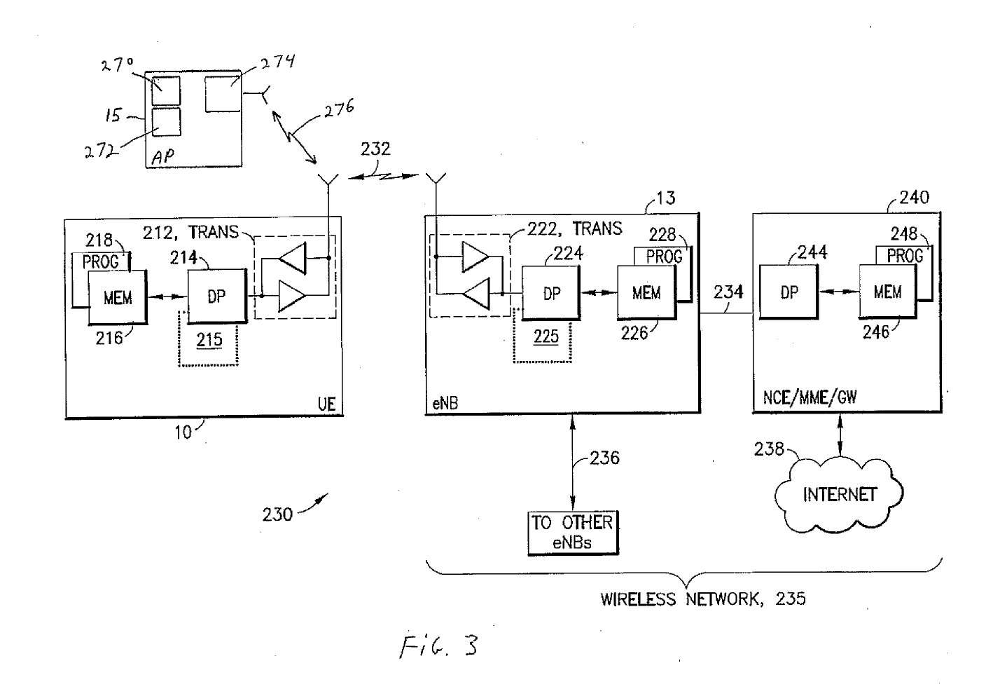

Referring also to FIG. 2, in this example a radio access network (RAN) has at least one cell 12. The cell 12 belongs to a base station 13 (such as an eNB for example). Another network has a cell 14 with an access point (AP), such as having WLAN AP 15. The two radio networks have cells 12, 14 which are at least partially overlapping. The WLAN Access Points may have WLAN authenticator role, but this role may be provided also by a WLAN controller if the WLAN network deploys them. A WLAN controller may host multiple WLAN APs. The WLAN authenticator may communicate with the RAN 235 (see FIG. 3) by a suitable connection, such as wired cable or telephone lines, and/or a wireless link for example. The Cell 12 of the RAN may operate on a licensed band and the Cell 14 of the other network may operate on an unlicensed band for example. The Cell 12 of the RAN may be either a FDD cell or TDD cell for example. For simplicity, there are just one Cell 12 of the RAN and one Cell 14 of the other network depicted in the scenario shown in FIG. 2. In other alternate examples any number of cells. (Cell 12 of the RAN and Cell 14 of the other network) operating on licensed and/or unlicensed band(s) may be provided including, for example, to work together for WLAN offloading or bearer aggregation. In one type of example embodiment the Cell 12 of the RAN and Cell 14 of the other network may be co-located.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

Referring also to FIG. 3, in the wireless system 230 a wireless network or RAN 235 is adapted for communication over a wireless link 232 with an apparatus, such as a mobile communication device which may be referred to as a UE 10, via a network access node, such as a Node B (base station), and more specifically an eNB 13. The network 235 may include a network control element (NCE) 240 that may include MME/S-GW functionality, and which provides connectivity with a network, such as a telephone network and/or a data communications network (e.g., the internet 238). It should be noted, however, features as described herein do not require that the UE actually be in contact with a NodeB or eNB. The UE merely needs to make contact with a WLAN node. In one example this contact results in a WLAN/RAN communication which may further result in a UE/RAN link setup, such as when the WLAN access was not authorized by RAN for example.

The UE 10 includes a controller, such as a computer or a data processor (DP) 214, a computer-readable memory medium embodied as a memory (MEM) 216 that stores a program of computer instructions (PROG) 218, and a suitable wireless interface, such as radio frequency (RF) transceiver 212, for wireless communications with the eNB 13 or with the WLAN access point (AP) 15 via one or more antennas.

The eNB 13 also includes a controller, such as a computer or a data processor (DP) 224, a computer-readable memory medium embodied as a memory (MEM) 226 that stores a program of computer instructions (PROG) 228, and a suitable wireless interface, such as RF transceiver 222, for communication with the UE 10 via one or more antennas. The eNB 13 is coupled via a data/control path 234 to the NCE 240. The path 234 may be implemented as an interface. The eNB 13 may also be coupled to another eNB or WLAN node via data/control path 236, which may be implemented as an interface.

The NCE 240 includes a controller, such as a computer or a data processor (DP) 244, a computer-readable memory medium embodied as a memory (MEM) 246 that stores a program of computer instructions (PROG) 248. However, in this example the NCE is not substantially relevant to EPC resources. Instead, the eNB or RNC and NodeB are more important in the examples described below.

At least one of the PROGs 218, 228 and 248 is assumed to include program instructions that, when executed by the associated DP, enable the device to operate in accordance with exemplary embodiments of this invention, as will be discussed below in greater detail. That is, various exemplary embodiments of this invention may be implemented at least in part by computer software executable by the DP 214 of the UE 10; by the DP 224 of the eNB 13; and/or by the DP 244 of the NCE 240, or by hardware, or by a combination of software and hardware (and firmware).

For the purposes of describing various exemplary embodiments in accordance with this invention the UE 10 and the eNB 13 may also include dedicated processors, for example RRC module 215 and a corresponding RRC module 225. RRC module 215 and RRC module 225 may be constructed so as to operate in accordance with various exemplary embodiments in accordance with this invention.

The computer readable MEMs 216, 226 and 246 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224 and 244 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 212 and 222) may be of any type suitable to the local technical environment and may be implemented using any suitable communication technology such as individual transmitters, receivers, transceivers or a combination of such components.

The access point 15 of the WLAN also comprises a processor 270, a memory 272 having computer code stored thereon and a radio frequency (RF) transceiver 274, for bidirectional wireless communications 276 with the UE 10 via one or more antennas. With features as described herein, the WLAN node (functioning as an authenticator) communicates with the 3GPP network. In this example the WLAN node is an Access Point (AP). In an alternate example the WLAN node comprises an WLAN Controller (WLC) in the WLAN network. In this alternative example the WLC may control several WLAN APs.

Features as described herein may be used to provide a RAN/WLAN interworking. RAN resource control happens in a eNB for an E-UTRAN system, and happens in a RNC for an UTRAN system. This is also the interworking point for a WLAN in RAN side. When a UE enters the WLAN, the WLAN network may contact the RAN for instructions regarding the UE. For example, the WLAN may request an instruction from the RAN of whether the WLAN should allow the UE to access the WLAN or if the WLAN should reject the request. If the WLAN is instructed by the RAN to reject the request by the UE, the UE may then join the RAN instead of the WLAN, such as if the UE does not have any other network to use for example. Essentially, the RAN executes load balancing and QoS assurance between RAN nodes and interworking WLAN nodes under the RAN area.

Conventionally, when the UE authenticates in the WLAN network with an AAA server, the AAA server would provide the subscriber data to the WLAN node. This happens, for example, in a trusted WLAN access (S2a interface) specified in Rel-12. However, as described herein, the same subscriber profile could be provided to any interworking WLAN node. A MAC address of a UE is conventionally meaningless to the RAN, and a RAN is unaware of a UE IMSI or any other identity that the AAA server might know for the UE. However, with features as described herein, one may avoid trying to identify the UE to the RAN via the WLAN if one only provides a subscriber profile for the UE to the RAN from the WLAN. This may be done with the MAC of a UE for example. Once the subscriber profile is provided to the RAN, the RAN may then do one or more actions. For example, an example action is traffic steering based on current RAN load, WLAN load, the subscriber profile and operator policies configured into the RAN. Accuracy is achievable since the RAN knows which WLAN BSS the UE is connected to (provided as part of the WLAN/RAN signaling), and under which RAN cell this WLAN BSS is physically present (O&M configuration/SON). The WLAN load could be available via a dedicated signaling, or as part of used RAN/WLAN signals for example.

With features as described herein, the AAA is configured to provide the subscriber profile for specific WLAN nodes as part of an SAP authentication; potentially on request or via other pre-configured information. For example, existing 3GPP defined RADIUS/Diameter IE can be used for this. Alternatively, proprietary IEs may be created instead. When the WLAN has this information available, the WLAN may include this information in the WLAN/RAN authorization signalling messages. The RAN may then use this information to implement traffic steering decision(s) between the WLAN and the RAN. This may be used to support subscriber-specific traffic steering without knowledge of the subscriber identity. These messages may also contain WLAN load information, UE MAC address and WLAN BSSID to support WLAN mobility scenarios. In the example described above, the WLAN obtains the subscriber profile as part of LAP authentication. However, use of an EAP to obtain the subscriber profile is merely an example. In an alternate example additional or alternative mechanism(s) could be used for the WLAN to get the subscriber profile.

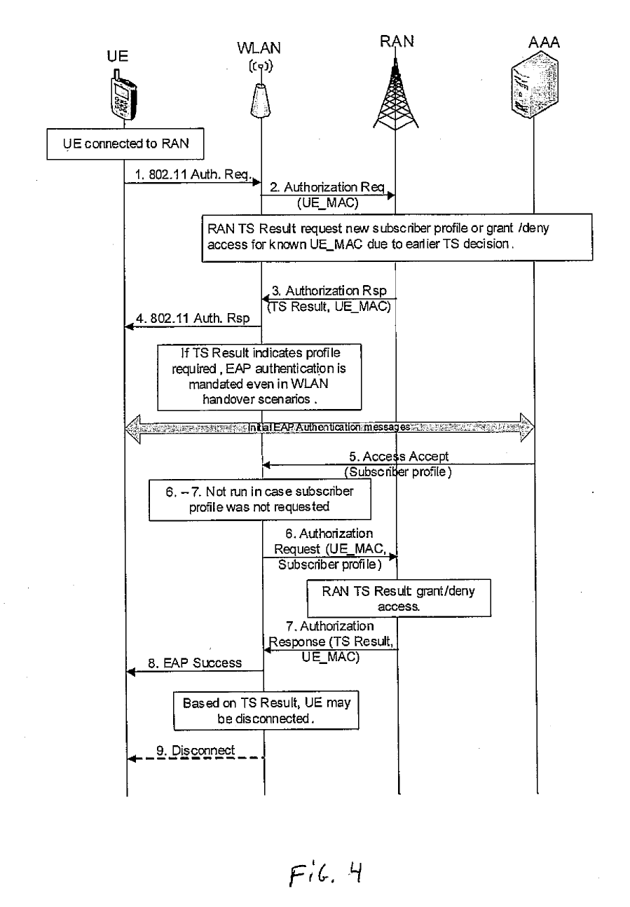

Referring also to FIG. 4, in one example the RAN may have a previously stored UE subscriber profile for the UE, such as stored relating to the MAC address of the UE. In this example, the WLAN may use a MAC authorization mechanism where the WLAN will request authorization from the RAN in the initial WLAN access (message 2 and 3 shown in FIG. 4). This may be done before EAP authorization; not just with or after EAP authentication as described in the alternate example described below. Thus, in this example the initial authorization by the RAN for the UE to use the WLAN may happen as part of 802.11 authentication signaling, or 802.11 (re-) association signaling, or other signaling before the EAP authentication is run. In an alternate example (where the initial authorization is requested before the EAP authentication is run) the RAN, may already have made a decision for the UE (to grant or deny use of the UE by the WLAN); done before the 802.11 authentication signaling, such as in regard to a different WLAN for example. Thus, in these first examples, based upon the subscriber profile for the UE being known by the RAN, based on a previously stored UE subscriber profile for the UE MAC address or decision done earlier for the UE (grant/deny), based on WLAN and RAN load information the initial traffic steering decision can be made by the RAN.

As noted above, the WLAN may provide the subscriber profile in the initial authorization sequence (step 2 in FIG. 4) if the subscriber profile is otherwise known to the WLAN. The WLAN may learn the subscriber profile from a previous or different WLAN network access. The subscriber profile may be exchanged between WLAN networks, for example between WLAN nodes within the mobility domain, such as when the WLAN security keys are exchanged between WLAN nodes for WLAN mobility for example.

The WLAN has several mobility mechanisms which work without new EAP authentication, such as by just reusing previously established security keys in the old WLAN nodes for example. OKC/PKC (Microsoft), CCKM (Cisco), Fast BSS Transition (802.11r FT) and Fast Initial Link Setup (802.11ai—FILS) are examples of these. Also in these cases, the RAN and WLAN may already know the cached subscriber profile of the UE (based on UE MAC address) from the previous WLAN authorization for the UE. In these cases both the RAN and/or the WLAN may use cached profile(s), but features are not limited to these cases. Even if the UE was to do a new EAP authentication, both the RAN and/or the WLAN may already have a cached profile.

With the examples described above, the final traffic steering decision can be made in the initial MAC authorization phase. However, in another example the RAN may not initially have the subscriber information of the UE when the MAC authorization request is first made. For example, the WLAN may transmit the MAC address of the UE to the RAN during step 2, and the RAN may recognize that the RAN does not have reasonable fresh cached subscriber information based on that MAC address. Thus, in a case where the MAC address of the UE is unknown to the RAN, and the RAN does not otherwise have reasonable fresh subscriber profile cache for the UE, the RAN may order or request the WLAN to acquire (if not already acquired by the WLAN) and supply the subscriber profile to the RAN. This may happen, for example, by enforcing EAP authentication, even when the UE is performing a WLAN handover which would not require new EAP authentication in the new WLAN node. Thus, the RAN may signal to the WLAN authenticator for the WLAN authenticator to acquire subscriber profile and to provide it to RAN for authorization decision if authorization request did not include one. WLAN authenticator could for example perform an EAP authentication with the AAA server to get the subscriber profile. The RAN may also indicate to the WLAN authenticator whether to authorize the WLAN access, or reject the WLAN access such as in case the subscriber profile is not available to the authenticator (AAA does not provide it).

If the RAN requests a subscriber profile in the initial authorization message exchange (step 3), the WLAN may execute a second authorization procedure (steps 6 and shown in FIG. 4) with the RAN and provide the subscriber profile to the RAN for the UE MAC address in the second authorization procedure. After this, the RAN may make a traffic steering decision(s) using the subscriber profile information and other available information, such as RAN and WLAN load, and operator policies for the subscriber profile for example.

The subscriber profile may include, for example, a default QoS profile. It may also include explicit user category, such as if such distinction is made in the AAA server. It can include any subscriber related data that is needed for traffic steering decisions, and may be without actually identifying specific user.

The authorization signaling between the WLAN authenticator and the RAN node can be based, for example, on RADIUS. However, in alternate examples other protocol(s) could be used. The WLAN node may receive the subscriber profile as part of EAP authentication execution with the UE and AAA server (such as piggybacked into RADIUS/DIAMETER protocols conveying EAP authentication messages between WLAN node and AAA server for example), or via a proprietary means in an alternate example. The UE and the WLAN node may use EAPOL protocol to exchange EAP payload. The WLAN may exchange this EAP payload with the AAA server using RADIUS or DIAMETER protocols. The EAP authentication is between the UE and the AAA; and the WLAN only passes the EAP messages through. The WLAN node may receive authentication result and security keys for radio ciphering from the AAA if result indicates successful authentication.

In one example, the WLAN may store subscriber profile for future use once received from the AAA. In this case the WLAN may provide the profile to the RAN even before UE executes EAP authentication with the AAA server. If authorization is denied, the network does not have to run EAP signaling at all, and the UE behavior may be more consistent as a result. Device behavior can be different depending upon when access is denied for example. Some UEs may keep attempting to re-connect to the network even if access was previously denied. How it is denied may affect the interval of the attempts for example. In one example, if the WLAN does not have the subscriber profile for the UE, then the RAN may request it in the authorization response if the RAN wishes to receive one before making a final authorization decision. In one example the RAN may also indicate a default action (accept/deny) if the WLAN is not able to provide a subscriber profile at all (AAA does not provide it).

In an alternate example, it may be possible for the RAN to learn the UE MAC address via RRC signaling from the UE, and the RAN may be able to associate a request from the WLAN to a specific UE. However, the RAN may not have a proper QoS profile for WLAN access which is provided here.

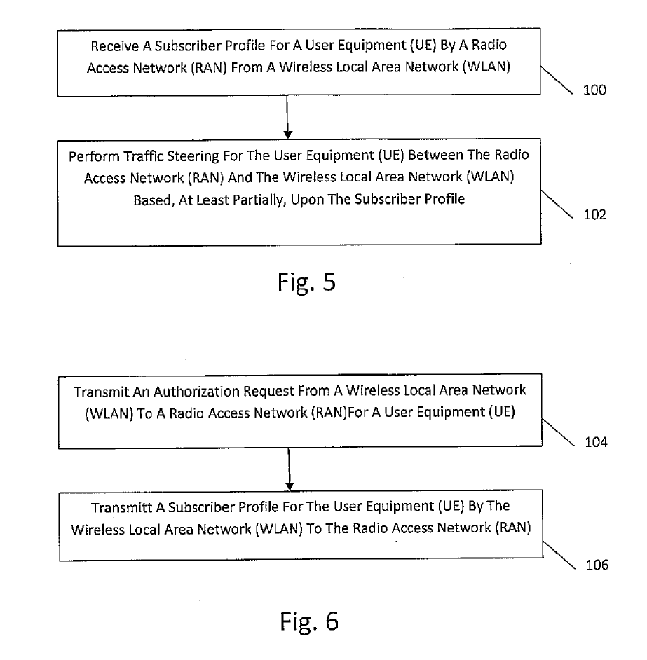

Referring also to FIG. 5, an example method may comprise receiving a subscriber profile for a user equipment (UE) by a radio access network (RAN) from a wireless local area network (WLAN) as indicated by block 100; and the radio access network (RAN) performing traffic steering for the user equipment (UE) between the radio access network (RAN) and the wireless local area network (WLAN) based, at least partially, upon the subscriber profile as indicated by block 102. The traffic steering may be performed by the RAN without a need for the RAN to know which RAN user the WLAN user is.

The subscriber profile may be received by the radio access network (RAN) in a WLAN/RAN authorization signaling message. The subscriber profile may be received by the radio access network (RAN) obtained as part of an extensible authentication protocol (EAP) authentication, or by the radio access network (RAN) before an extensible authentication protocol (EAP) authentication, or by the radio access network (RAN) from another radio access network, where the other radio access network received the subscriber profile from a WLAN. The method may further comprise receiving, by the radio access network (RAN) from the wireless local area network (WLAN), a media access control (MAC) address of the user equipment (UE). The subscriber profile may be received by the radio access network (RAN) before an extensible authentication protocol (EAP) authentication is executed between UE and AAA in WLAN network or after this. The method may further comprise the radio access network (RAN) requesting the wireless local area network (WLAN) to obtain the subscriber profile of the user equipment (UE). The method may further comprise the radio access network (RAN) performing traffic steering for the user equipment (UE) between the radio access network (RAN) and a second different wireless local area network (WLAN) based, at least partially, upon the subscriber profile received by the radio access network (RAN).

An example embodiment may be provided in an apparatus, such as shown in FIG. 3 for example, comprising at least one processor; and at least one non-transitory memory including computer program code, the at least one memory and the computer program code are configured to, with the at least one processor, cause the apparatus to receive a subscriber profile for a user equipment (UE) by the apparatus from a wireless local area network (WLAN), where the apparatus forms at least part of a radio access network (RAN); and the apparatus performing traffic steering for the user equipment (UE) between the radio access network (RAN) and the wireless local area network (WLAN) based, at least partially, upon the subscriber profile.

The at least one memory and the computer program code may be configured to, with the at least one processor, cause the apparatus to receive the subscriber profile by the radio access network (RAN) in a WLAN/RAN authorization signaling message. The at least one memory and the computer program code may be configured to, with the at least one processor, cause the apparatus to receive the subscriber profile by the radio access network (RAN) as part of the WLAN/RAN authorization signaling message, either automatically included into the initial authorization request, or in a second authorization request such as if this was explicitly required by the RAN in the initial authorization response for example. The at least one memory and the computer program code may be configured to, with the at least one processor, cause the apparatus to receive, by the radio access network (RAN) from the wireless local area network (WLAN), a media access control (MAC) address of the user equipment (DE). The at least one memory and the computer program code may be configured to, with the at least one processor, cause the apparatus to receive the subscriber profile by the radio access network (RAN) before or after an extensible authentication protocol (EAP) authentication. The at least one memory and the computer program code may be configured to, with the at least one processor, cause the apparatus to request, by the radio access network (RAN), the wireless local area network (WLAN) to obtain the subscriber profile of the user equipment (UE). The at least one memory and the computer program code may be configured to, with the at least one processor, cause the apparatus to perform traffic steering, by the radio access network (RAN), for the user equipment (UE) between the radio access network (RAN) and a second different wireless local area network (WLAN) based, at least partially, upon the subscriber profile received by the radio access network (RAN).

An example embodiment may be provided in a non-transitory program storage device, such as one of the memories shown in FIG. 3 for example, readable by a machine, tangibly embodying a program of instructions executable by the machine for performing operations, the operations comprising: receiving a subscriber profile for a user equipment (UE) by a radio access network (RAN) from a wireless local area network (WLAN); and the radio access network (RAN) performing traffic steering for the user equipment (UE) between the radio access network (RAN) and the wireless local area network (WLAN) based, at least partially, upon the subscriber profile.

Referring also to FIG. 6, an example method may comprise transmitting an authorization request from a wireless local area network (WLAN) to a radio access network (RAN) for a user equipment (UE) as indicated by block 104; and transmitting a subscriber profile for the user equipment (UE) by the wireless local area network (WLAN) to the radio access network (RAN) as indicated by block 106.

Transmitting the authorization request may comprise transmitting a media access control (MAC) address of the user equipment (UE) with the authorization request. The transmitting of the subscriber profile may occur prior to the transmitting of the authorization request. The transmitting of the authorization request may occur prior to the transmitting of the subscriber profile. Transmitting of the subscriber profile from AAA server to WLAN node may occur as part of an extensible authentication protocol (EAP) authentication. The subscriber profile may be transmitted by the wireless local area network (WLAN) in a WLAN/RAN authorization signaling message. The subscriber profile may be transmitted by the wireless local area network (WLAN) before an extensible authentication protocol (EAP) authentication. The method may further comprise the wireless local area network (WLAN) receiving a request from the radio access network (RAN) to obtain the subscriber profile of the user equipment (UE) and instructions how to proceed (accept/deny) in case subscriber profile cannot be provided (AAA does not provide it). The method may further comprise transmitting the subscriber profile by the wireless local area network (WLAN) to a second different wireless local area network (WLAN).

An example embodiment may be provide in an apparatus, such as shown in FIG. 3 for example, comprising at least one processor; and at least one non-transitory memory including computer program code, the at least one memory and the computer program code are configured to, with the at least one processor, cause the apparatus to: transmit an authorization request from the apparatus to a radio access network (RAN) for a user equipment (UE), where the apparatus is at least part of a wireless local area network (WLAN); and transmit a subscriber profile for the user equipment (UE) by the apparatus to the radio access network (RAN).

The at least one memory and the computer program code may be configured to, with the at least one processor, cause the apparatus to transmit the authorization request including transmitting a media access control (MAC) address of the user equipment (UE) with the authorization request. The at least one memory and the computer program code may be configured to, with the at least one processor, cause the apparatus to transmit the subscriber profile prior to the transmitting of the authorization request. For example, the RAN may have the subscriber profile stored in a memory and the transmitting of the authorization request may merely comprise the MAC address for the UE; which the RAN subsequently uses to identify the previously stored subscriber profile. The at least one memory and the computer program code may be configured to, with the at least one processor, cause the apparatus to transmit the authorization request prior to the transmitting of the subscriber profile. The at least one memory and the computer program code may be configured to, with the at least one processor, cause the apparatus to transmit the subscriber profile obtained as part of an extensible authentication protocol (EAP) authentication from AAA server to WLAN authenticator. The at least one memory and the computer program code may be configured to, with the at least one processor, cause the apparatus to transmit the subscriber profile by the wireless local area network (WLAN) in a WLAN/RAN authorization signaling message. The at least one memory and the computer program code may be configured to, with the at least one processor, cause the apparatus to transmit the subscriber profile by the wireless local area network (WLAN) before an extensible authentication protocol (EAP) authentication. The at least one memory and the computer program code may be configured to, with the at least one processor, cause the apparatus to receive by the wireless local area network (WLAN) a request from the radio access network (RAN) to obtain the subscriber profile of the user equipment (UE). The at least one memory and the computer program code may be configured to, with the at least one processor, cause the apparatus to transmit the subscriber profile by the wireless local area network (WLAN) to a second different wireless local area network (WLAN).

An example embodiment may be provided in a non-transitory program storage device, such as the memory 272 shown in FIG. 3 for example, readable by a machine, tangibly embodying a program of instructions executable by the machine for performing operations, the operations comprising: transmitting an authorization request from a wireless local area network (WLAN) to a radio access network (RAN) for a user equipment (UE); and transmitting a subscriber profile for the user equipment (UE) by the wireless local area network (WLAN) to the radio access network (RAN).

Any combination of one or more computer readable medium(s) may be utilized as a memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

A communications system and/or a network node/base station may comprise a network node or other network elements implemented as a server, host or node operationally coupled to a remote radio head. At least some core functions may be carried out as software run in a server (which could be in the cloud) and implemented with network node functionalities in a similar fashion as much as possible (taking latency restrictions into consideration). This is called network virtualization. “Distribution of work” may be based on a division of operations to those which can be run in the cloud, and those which have to be run in the proximity for the sake of latency requirements. In macro cell/small cell networks, the “distribution of work” may also differ between a macro cell node and small cell nodes. Network virtualization may comprise the process of combining hardware and software network resources and network functionality into a single, software-based administrative entity, a virtual network. Network virtualization may involve platform virtualization, often combined with resource virtualization. Network virtualization may be categorized as either external, combining many networks, or parts of networks, into a virtual unit, or internal, providing network-like functionality to the software containers on a single system.

Features as described herein may provide a means for the RAN to recognize the UE when the WLAN requests guidance from the RAN. In one example mapping between the UE in an LTE connection and the UE in a WLAN connection may thus be provided. Thus, depending on user classification, in order to enforce QoS and service classes the RAN does not have to behave differently. In another example mapping between the UE in an LTE connection and the UE in a WLAN connection might not be provided. A RAN may have a subscriber profile for its own users in the RAN, received from MME/SGSN for example. However, with features as described herein, the WLAN may initially provide the subscriber profile to RAN regarding the WLAN user. Thus, the RAN may receive the subscriber profile from the WLAN rather than from the MME/SGSN. The RAN may receive the subscriber profile before the UE is connected to the RAN and, thus, control traffic steering even before the UE is connected to the RAN. The RAN may cache the subscriber profile for future use, and the RAN may also provide the subscriber profile to a new RAN due to mobility. The same also goes for the WLAN too; the subscriber profile may be cached and/or shared with another WLAN.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A method comprising:
receiving a subscriber profile for a user equipment (UE) in a wireless local area network (WLAN) by a radio access network (RAN); and
the radio access network (RAN) performing traffic steering for the user equipment (UE) between the radio access network (RAN) and at least one wireless local area network (WLAN) based, at least partially, upon the subscriber profile.

2. A method as in claim 1 where the subscriber profile is received by at least one of:
the radio access network (RAN) in a WLAN/RAN authorization signaling message;
the radio access network (RAN) obtained as part of an extensible authentication protocol (EAP) authentication by the WLAN;
the radio access network (RAN) before an extensible authentication protocol (EAP) authentication; and
the radio access network (RAN) from another radio access network, where the another radio access network received the subscriber profile from a WLAN.

3. A method as in claim 1 further comprising receiving, by the radio access network (RAN) from the wireless local area network (WLAN), a media access control (MAC) address of the user equipment (UE).

4. A method as in claim 1 further comprising the radio access network (RAN) requesting the wireless local area network (WLAN) to obtain the subscriber profile of the user equipment (UE).

5. A method as in claim 1 further comprising the radio access network (RAN) performing traffic steering for the user equipment (UE) between the radio access network (RAN) and a second different wireless local area network (WLAN) based, at least partially, upon the subscriber profile received by the radio access network (RAN).

6. An apparatus comprising:
at least one processor; and
at least one non-transitory memory including computer program code, the at least one memory and the computer program code are configured to, with the at least one processor, cause the apparatus to:
receive a subscriber profile for a user equipment (UE) in a wireless local area network (WLAN) by the apparatus, where the apparatus forms at least part of a radio access network (RAN); and
the apparatus performing traffic steering for the user equipment (UE) between the radio access network (RAN) and at least one wireless local area network (WLAN) based, at least partially, upon the subscriber profile.

7. An apparatus as in claim 6 where the at least one memory and the computer program code are configured to, with the at least one processor, cause the apparatus to receive the subscriber profile by at least one of:
the radio access network (RAN) in a WLAN/RAN authorization signaling message;
the radio access network (RAN) obtained as part of an extensible authentication protocol (EAP) authentication; and
the radio access network (RAN) before an extensible authentication protocol (EAP) authentication.

8. An apparatus as in claim 6 where the at least one memory and the computer program code are configured to, with the at least one processor, cause the apparatus to receive, by the radio access network (RAN) from the wireless local area network (WLAN), a media access control (MAC) address of the user equipment (UE).

9. An apparatus as in claim 6 where the at least one memory and the computer program code are configured to, with the at least one processor, cause the apparatus to request, by the radio access network (RAN), the wireless local area network (WLAN) to obtain the subscriber profile of the user equipment (UE).

10. An apparatus as in claim 6 where the at least one memory and the computer program code are configured to, with the at least one processor, cause the apparatus to perform traffic steering, by the radio access network (RAN), for the user equipment (UE) between the radio access network (RAN) and a second different wireless local area network (WLAN) based, at least partially, upon the subscriber profile received by the radio access network (RAN).

11. A method comprising:
transmitting an authorization request from a wireless local area network (WLAN) to a radio access network (RAN) for a user equipment (UE); and
transmitting a subscriber profile for the user equipment (UE) by the wireless local area network (WLAN) to the radio access network (RAN).

12. A method as in claim 11 where transmitting the authorization request comprises transmitting a media access control (MAC) address of the user equipment (UE) with the authorization request.

13. A method as in claim 11 where the transmitting of the subscriber profile occurs at at least one of:
prior to the transmitting of the authorization request;
after the subscriber profile is obtained as part of an extensible authentication protocol (EAP) authentication;
a WLAN/RAN authorization signaling message by the wireless local area network (WLAN);
before an extensible authentication protocol (EAP) authentication by the wireless local area network (WLAN); and
the wireless local area network (WLAN) from a second different wireless local area network (WLAN).

14. A method as in claim 11 where the transmitting of the authorization request occurs prior to the transmitting of the subscriber profile.

15. A method as in claim 11 further comprising the wireless local area network (WLAN) receiving a request from the radio access network (RAN) to obtain the subscriber profile of the user equipment (UE).

16. An apparatus comprising:
at least one processor; and
at least one non-transitory memory including computer program code, the at least one memory and the computer program code are configured to, with the at least one processor, cause the apparatus to:
transmit an authorization request from the apparatus to a radio access network (RAN) for a user equipment (UE), where the apparatus is at least part of a wireless local area network (WLAN); and
transmit a subscriber profile for the user equipment (UE) by the apparatus to the radio access network (RAN).

17. An apparatus as in claim 16 where the at least one memory and the computer program code are configured to, with the at least one processor, cause the apparatus to transmit the authorization request including transmitting a media access control (MAC) address of the user equipment (UE) with the authorization request.

18. An apparatus as in claim 16 where the at least one memory and the computer program code are configured to, with the at least one processor, cause the apparatus to transmit the subscriber profile at at least one of:
prior to the transmitting of the authorization request;
after the subscriber profile is obtained as part of an extensible authentication protocol (EAP) authentication;
a WLAN/RAN authorization signaling message by the wireless local area network (WLAN);
before an extensible authentication protocol (EAP) authentication by the wireless local area network (WLAN); and
the wireless local area network (WLAN) from a second different wireless local area network (WLAN).

19. An apparatus as in claim 16 where the at least one memory and the computer program code are configured to, with the at least one processor, cause the apparatus to transmit the authorization request prior to the transmitting of the subscriber profile.

20. An apparatus as in claim 16 where the at least one memory and the computer program code are configured to, with the at least one processor, cause the apparatus to receive by the wireless local area network (WLAN) a request from the radio access network (RAN) to obtain the subscriber profile of the user equipment (UE).
